(19) United States
(12) Patent Application Publication
(10) Pub. No.: US 2017/0210293 A1
(43) Pub. Date: Jul. 27, 2017

(54) VIDEO GENERATION DEVICE AND VIDEO GENERATION METHOD

(71) Applicant: FUJITSU LIMITED, Kawasaki-shi (JP)

(72) Inventors: Yasushi Sugama, Yokohama (JP); Yusaku Fujii, shinjuku (JP); Takato OHASHI, Kawasaki (JP)

(73) Assignee: FUJITSU LIMITED, Kawasaki-shi (JP)

(21) Appl. No.: 15/383,199

(22) Filed: Dec. 19, 2016

(30) Foreign Application Priority Data
Jan. 27, 2016 (JP) 2016-013828

(51) Int. Cl. B60R 1/00; G06T 7/70; G06T 7/246; G06K 9/00

(52) U.S. Cl. CPC B60R 1/00; G06K 9/00805; G06T 7/70; G06T 7/246; B60R 2300/10; B60R 2300/8093; B60R 2300/205; G06T 2207/10016

(57) ABSTRACT

A video generation device includes a processor configured to detect a second vehicle present in front of a first vehicle or behind the first vehicle in a first direction in which the first vehicle travels. The first vehicle is mounted with the video generation device. The processor is configured to detect a first distance between the first vehicle and the second vehicle. The processor is configured to compare the first distance to a predetermined threshold value to acquire a first comparison result. The processor is configured to determine a first speed of a first image on basis of the first comparison result. The first image is included in a video and to be moved within the video in a direction determined on basis of the first direction. The processor is configured to generate the video on basis of the first speed and display the video via a display device.

### CROSS-REFERENCE TO RELATED APPLICATION

This application is based upon and claims the benefit of priority of the prior Japanese Patent Application No. 2016-013828 filed on Jan. 27, 2016, the entire contents of which are incorporated herein by reference.

### FIELD

The embodiments discussed herein are related to a video generation device, and a video generation method.

### BACKGROUND

A traffic accident by a vehicle such as, for example, a four-wheeled vehicle is mainly caused by an excessive speed or an insufficient inter-vehicular distance. Further, when a driver does not notice that the driving road surface is uphill, the driver continues to drive the vehicle without changing a stepping amount of the accelerator and the vehicular speed is reduced, which is known as one of factors causing a traffic jam.

As one of techniques of allowing a vehicle driver to maintain a proper vehicular speed, there is known a technology of guiding the driver to slow down when the traveling speed (vehicular speed) of the vehicle exceeds a predetermined speed.

As one of techniques of guiding a driver to a deceleration operation or an acceleration operation, there is known a technology of guiding the driver by controlling the light emission time of light-emitting objects arranged along a road so as to impart a visually induced self-motion illusion (vection) to the driver.

A related technique is disclosed in, for example, Japanese Laid-Open Patent Publication No. 2013-159915.

When the light emission time of light-emitting objects arranged along a road is controlled, it is very difficult to control the light emission time in response to a traveling state (a vehicular speed, an inter-vehicular distance, or the like) of respective vehicles. Therefore, it is difficult to impart a proper vection to respective vehicle drivers to guide the driver to a deceleration operation or an acceleration operation.

### SUMMARY

According to an aspect of the present invention, provided is a video generation device including a memory and a processor coupled to the memory. The processor is configured to detect a second vehicle present in front of a first vehicle or behind the first vehicle in a first direction in which the first vehicle travels. The first vehicle is mounted with the video generation device. The processor is configured to detect a first distance between the first vehicle and the second vehicle upon detecting the second vehicle. The processor is configured to compare the first distance to a predetermined threshold value to acquire a first comparison result. The processor is configured to determine a first speed of a first image on basis of the first comparison result. The first image is included in a video and to be moved within the video in a direction determined on basis of the first direction. The processor is configured to generate the video on basis of the first speed. The processor is configured to display the video via a display device.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a guide system according to a first embodiment;

FIG. 2 is a diagram illustrating an exemplary functional configuration of a video generation device according to the first embodiment;

FIG. 3A is a flowchart illustrating a video display process according to the first embodiment;

FIG. 3B is a flowchart illustrating the video display process according to the first embodiment;

FIG. 3C is a flowchart illustrating the video display process according to the first embodiment;

FIG. 4A is a diagram illustrating an example of a displayed video;

FIG. 4B is a diagram illustrating an example of a displayed video;

FIG. 5 is a diagram illustrating an exemplary configuration of a guide system according to a second embodiment;

FIG. 6 is a diagram illustrating an exemplary functional configuration of a video generation device according to the second embodiment;

FIG. 7A is a flowchart illustrating a video display process according to the second embodiment;

FIG. 7B is a flowchart illustrating the video display process according to the second embodiment;

FIG. 7C is a flowchart illustrating the video display process according to the second embodiment; and

FIG. 8 is a diagram illustrating an exemplary hardware configuration of a computer.

### DESCRIPTION OF EMBODIMENTS

### First Embodiment

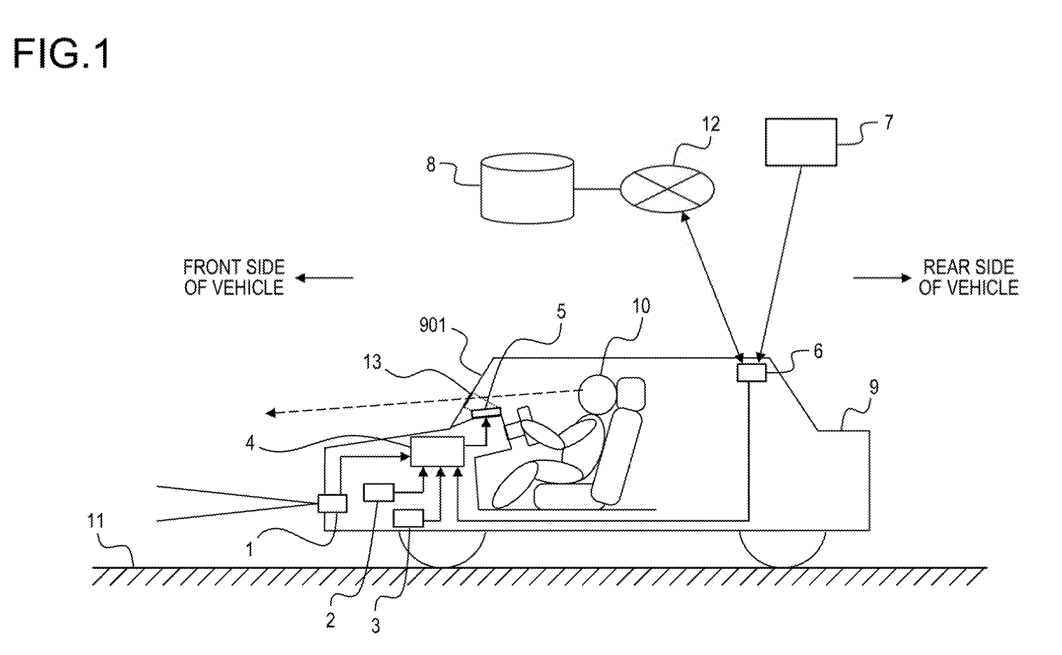

FIG. 1 is a diagram illustrating an exemplary configuration of a guide system according to a first embodiment.

As illustrated in FIG. 1, the guide system according to the first embodiment includes a distance sensor 1, a vehicular speed sensor 2, a tilt sensor 3, a video generation device 4, a display device 5, a radio communication device 6, a position information provision device 7, and a speed limit database (DB) 8. The distance sensor 1, the vehicular speed sensor 2, the tilt sensor 3, the video generation device 4, the display device 5, and the radio communication device 6 are mounted in a vehicle 9.

The distance sensor 1 is a sensor that detects a distance between the vehicle 9 and an object such as another vehicle present in front (in a traveling direction) of the vehicle 9. The vehicular speed sensor 2 is a speed sensor that detects a traveling speed of the vehicle 9. The tilt sensor 3 is an angle sensor that detects an inclination angle of a vehicle body in the front-back direction of the vehicle 9.

The video generation device 4 generates a video that guides a driver 10 of the vehicle 9 in relation to an operation of adjusting the traveling speed of the vehicle 9. Videos generated by the video generation device 4 are generally classified into a video that guides the driver 10 to an operation of maintaining the current vehicular speed, a video that guides the driver 10 to a deceleration operation, and a video that guides the driver 10 to an acceleration operation. The video generation device 4 generates a video that guides the driver 10 on the basis of a speed limit (a maximum speed at which a vehicle is allowed to travel on a road) of a road 11 where the vehicle 9 is traveling, a traveling speed of the vehicle 9, a distance from an object present in front of the vehicle 9, an inclination angle of the vehicle 9, and the like. The video generation device 4 acquires position information of the vehicle 9 from the position information provision device 7 such as a global positioning system (GPS) satellite through the radio communication device 6. The video generation device 4 accesses a communication network 12 such as the Internet through the radio communication device 6 to acquire the speed limit of the road 11 where the vehicle 9 is currently traveling from the speed limit DB 8 over the communication network 12.

The display device 5 displays a video generated by the video generation device 4. The display device 5 is provided to display the video generated by the video generation device 4 within the visual field of the driver 10 who is driving the vehicle 9. As the display device 5, for example, a head-up display (HUD) that projects and displays a video 13 on a windshield 901 or the like of the vehicle 9 may be used.

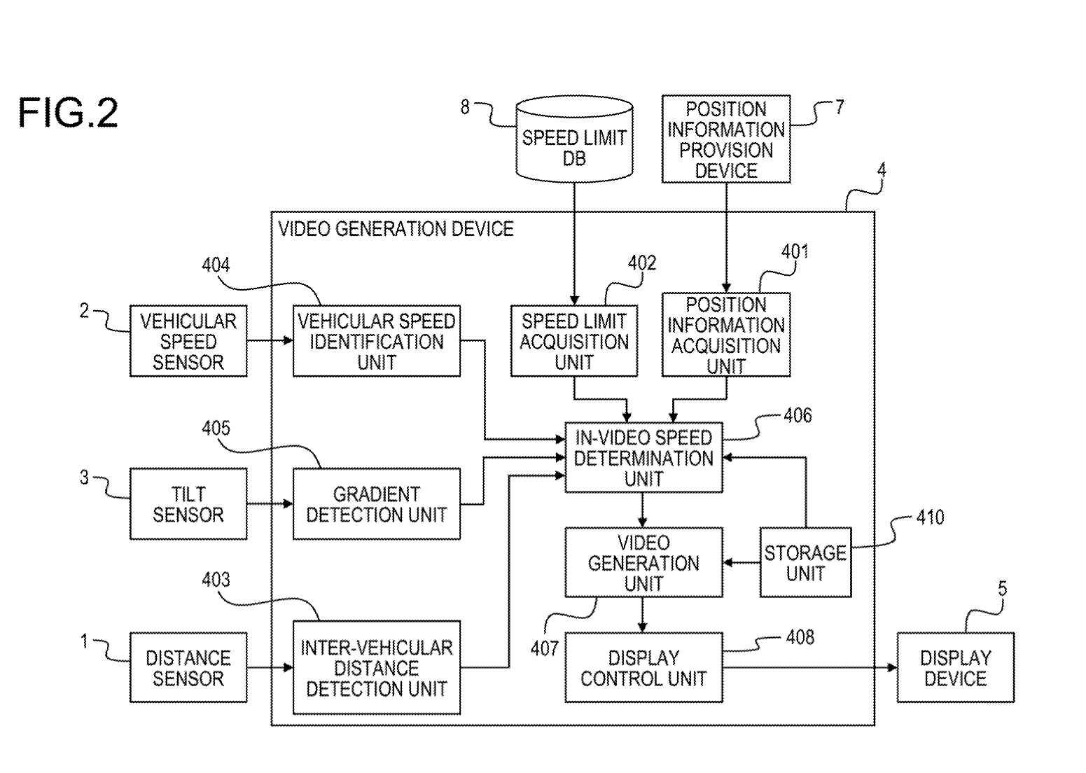

FIG. 2 is a diagram illustrating an exemplary functional configuration of the video generation device according to the first embodiment.

As illustrated in FIG. 2, the video generation device 4 includes a position information acquisition unit 401, a speed limit acquisition unit 402, an inter-vehicular distance detection unit 403, a vehicular speed identification unit 404, a gradient detection unit 405, an in-video speed determination unit 406, a video generation unit 407, and a display control unit 408. The video generation device 4 also includes a storage unit 410.

The position information acquisition unit 401 acquires position information of the vehicle 9 from the position information provision device 7 using a GPS or the like.

The speed limit acquisition unit 402 acquires the speed limit of the road 11 where the vehicle 9 is traveling from the speed limit DB 8 on the basis of the position information of the vehicle 9.

The inter-vehicular distance detection unit 403 detects an inter-vehicular distance between an own vehicle and another vehicle present in front of the own vehicle on the basis of the output of the distance sensor 1. The own vehicle is the vehicle 9 mounted with the distance sensor 1 used for detecting the inter-vehicular distance in the video generation device 4 (the inter-vehicular distance detection unit 403). That is, the own vehicle refers to the vehicle 9 driven by the driver 10 to be guided using a video generated by the video generation device 4.

The vehicular speed identification unit 404 identifies a current vehicular speed of the own vehicle 9 on the basis of the output of the vehicular speed sensor 2.

The gradient detection unit 405 detects an inclination angle of a vehicle body of the own vehicle 9 in the front-back direction, that is, a gradient of the road 11 (road surface) where the own vehicle is traveling, on the basis of the output of the tilt sensor 3.

The in-video speed determination unit 406 determines a movement speed of a guide image within the video that guides the driver 10, on the basis of information such as the speed limit of the road 11 where the vehicle 9 is traveling, the traveling speed of the vehicle 9, the inter-vehicular distance ahead of the vehicle 9, the gradient of the road 11, and information such as threshold values stored in the storage unit 410.

The video generation unit 407 generates a video including a guide image on the basis of the movement speed determined by the in-video speed determination unit 406. The video generation unit 407 reads data serving as materials for the video, including data of the guide image, from the storage unit 410 to generate the video.

The display control unit 408 causes the display device 5 to display the video generated by the video generation unit 407.

In the storage unit 410, various threshold values used for determining the movement speed of the guide image, data serving as materials for the video, including data of the guide image, and the like are stored.

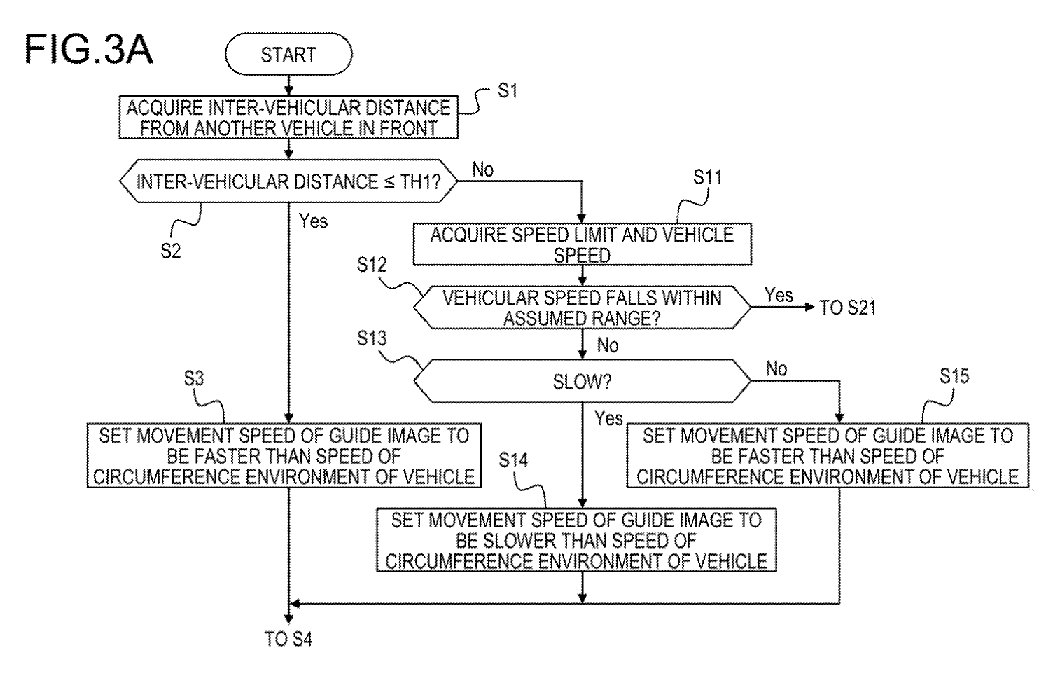

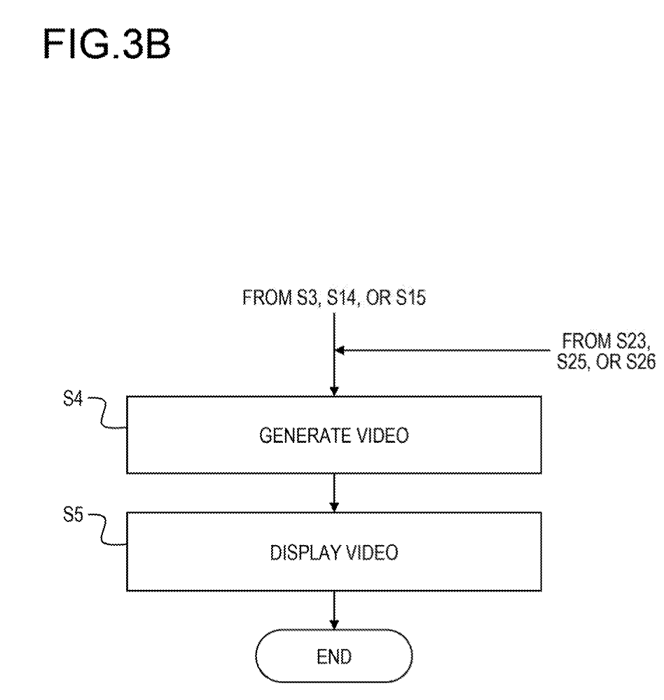

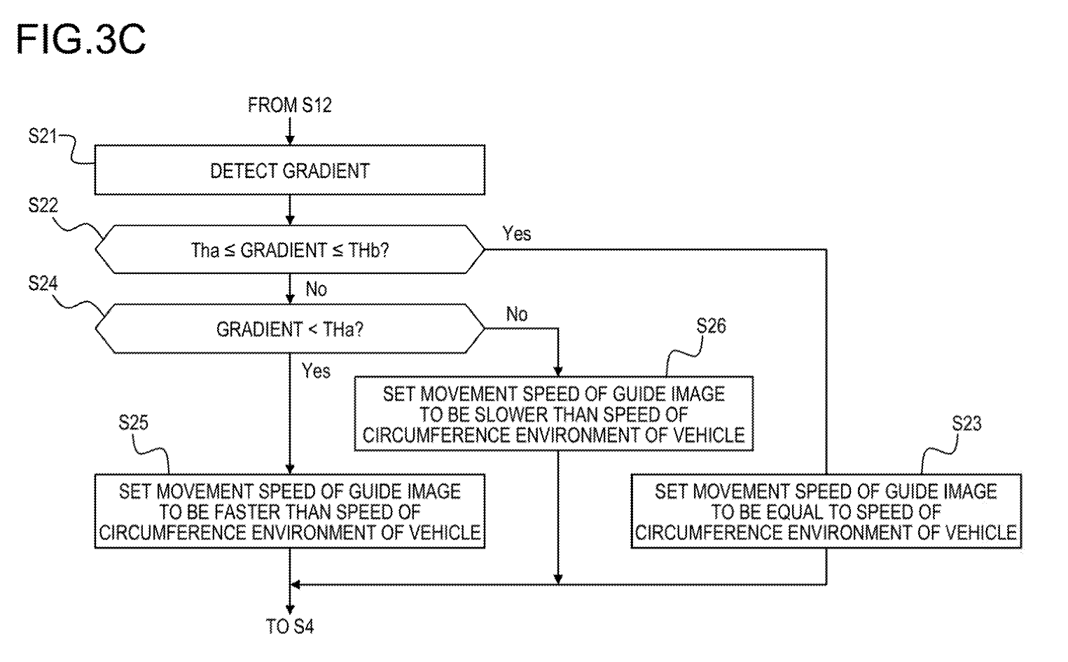

The video generation device 4 in the guide system according to the present embodiment repeatedly executes a video display process illustrated in FIGS. 3A to 3C at predetermined time intervals while the driver 10 drives the vehicle 9.

FIGS. 3A to 3C are flowcharts illustrating the video display process according to the first embodiment.

As illustrated in FIG. 3A, the video generation device 4 of the present embodiment acquires an inter-vehicular distance from another vehicle in front (S1). For example, the in-video speed determination unit 406 causes the inter-vehicular distance detection unit 403 to perform the processing in S1. The inter-vehicular distance detection unit 403 acquires the output of the distance sensor 1 to detect (calculate) an inter-vehicular distance between the own vehicle and another vehicle present in front of the own vehicle. The inter-vehicular distance detection unit 403 notifies the in-video speed determination unit 406 of the detected inter-vehicular distance.

Next, the video generation device 4 causes the in-video speed determination unit 406 to determine whether the inter-vehicular distance is equal to or less than a first threshold value TH1 (S2).

When it is determined that the inter-vehicular distance is equal to or less than the threshold value TH1 (S2; Yes), the in-video speed determination unit 406 sets, on the basis of the inter-vehicular distance, the movement speed of a guide image within a video to be faster than a speed corresponding to a vertical component of a movement velocity of the circumference environment of the vehicle within the video (S3). Hereinafter, for sake of simplicity, the speed corresponding to the vertical component of the movement velocity of the circumference environment of the vehicle within the video is referred to as a vertical movement speed of the circumference environment. In S3, the in-video speed determination unit 406 determines the movement speed of the guide image as a speed faster than a reference speed. The reference speed is, for example, the vertical movement speed of the circumference environment, which is determined on the basis of a current vehicular speed, a video size, or the like. The in-video speed determination unit 406 notifies the video generation unit 407 of the determined movement speed.

After the movement speed of the guide image is determined in S3, the video generation device 4 causes the video generation unit 407 to generate a video on the basis of the determined movement speed (S4), as illustrated in FIG. 3B. The video generation unit 407 reads data serving as materials for the video to be generated, including data of the guide image, from the storage unit 410 to generate the video. The video generation unit 407 transmits the generated video to the display control unit 408. Next, the video generation device 4 causes the display control unit 408 to display the video generated by the video generation unit 407 on the display device 5 (S5). When the processing in S5 is ended, the video generation device 4 starts a next video display process.

When it is determined that the inter-vehicular distance acquired in S1 exceeds the threshold value TH1 or when the inter-vehicular distance is not acquired in S1 (S2; No), the in-video speed determination unit 406 acquires a speed limit and a current vehicular speed (S11). In the processing of acquiring the speed limit in S11, the in-video speed determination unit 406 causes the position information acquisition unit 401 to acquire current position information of the vehicle 9. The position information acquisition unit 401 acquires the current position information of the vehicle 9 from the position information provision device 7 through the radio communication device 6, and notifies the in-video speed determination unit 406 of the acquired position information. Then, the in-video speed determination unit 406 notifies the speed limit acquisition unit 402 of the current position information of the vehicle 9, and causes the speed limit acquisition unit 402 to acquire the speed limit of the road 11 where the vehicle 9 is traveling. The speed limit acquisition unit 402 acquires the speed limit of the road 11 where the vehicle 9 is traveling from the speed limit DB 8 over the communication network 12 through the radio communication device 6, and notifies the in-video speed determination unit 406 of the acquired speed limit. In the processing of acquiring the current vehicular speed in S11, the in-video speed determination unit 406 causes the vehicular speed identification unit 404 to identify the current vehicular speed. The vehicular speed identification unit 404 acquires the output of the vehicular speed sensor 2 to identify the vehicular speed, that is, the current traveling speed of the vehicle 9. The vehicular speed identification unit 404 notifies the in-video speed determination unit 406 of the identified vehicular speed.

When the processing in S11 is ended, the in-video speed determination unit 406 subsequently determines whether the vehicular speed falls within an assumed range (S12). The in-video speed determination unit 406 assumes the range of the vehicular speed on the basis of the speed limit acquired in S11 to determine whether the current vehicular speed falls within the assumed range. The assumed range of the vehicular speed when the speed limit is X (km/h) may be appropriately set. The vehicular speed is set to be, for example, X-5 (km/h) or more, and X+5 (km/h) or less. When it is determined that the current vehicular speed falls within the assumed range (S12; Yes), the in-video speed determination unit 406 subsequently performs processing in S21 as illustrated in FIG. 3C.

When it is determined that the current vehicular speed is out of the assumed range (S12; No), the in-video speed determination unit 406 subsequently determines whether the current vehicular speed is slower than the assumed range (S13). When it is determined that the vehicular speed is slower than the assumed range (S13; Yes), the in-video speed determination unit 406 sets the movement speed of the guide image within the video to be slower than the vertical movement speed of the circumference environment on the basis of the vehicular speed (S14). In S14, the in-video speed determination unit 406 determines the movement speed of the guide image within the video as a speed slower than the reference speed. The in-video speed determination unit 406 notifies the video generation unit 407 of the determined movement speed. When it is determined that the vehicular speed is faster than the assumed range (S13; No), the in-video speed determination unit 406 sets the movement speed of the guide image within the video to be faster than the vertical movement speed of the circumference environment on the basis of the vehicular speed (S15). In S15, the in-video speed determination unit 406 determines the movement speed of the guide image within the video as a speed faster than the reference speed. The in-video speed determination unit 406 notifies the video generation unit 407 of the determined movement speed.

After the movement speed of the guide image is determined in S14 or S15, the video generation device 4 causes the video generation unit 407 to generate a video on the basis of the determined movement speed (S4), as illustrated in FIG. 3B. The video generation unit 407 reads data serving as materials for the video to be generated, including data of the guide image, from the storage unit 410 to generate the video. The video generation unit 407 transmits the generated video to the display control unit 408. Next, the video generation device 4 causes the display control unit 408 to display the video generated by the video generation unit 407 on the display device 5 (S5). When the processing in S5 is ended, the video generation device 4 starts a next video display process.

When it is determined that the current vehicular speed falls within the assumed range (S12; Yes), as described above, the in-video speed determination unit 406 subsequently acquires a gradient of the road surface (the road 11) (S21) as illustrated in FIG. 3C. In S21, the in-video speed determination unit 406 causes the gradient detection unit 405 to detect the gradient of the road surface. The gradient detection unit 405 detects the gradient of the road surface (road 11) where the vehicle 9 is traveling on the basis of the output of the tilt sensor 3. The gradient (inclination angle) of the road surface is set to 0 degrees when the road surface is horizontal, and is set to be positive when the road surface is uphill. The gradient detection unit 405 notifies the in-video speed determination unit 406 of the detected gradient of the road surface.

When the processing in S21 is ended, the in-video speed determination unit 406 subsequently determines whether the gradient is a first angle threshold value THa or more, and a second angle threshold value THb or less (S22). The first angle threshold value THa is a negative value, that is, a gradient threshold value in the case of a downhill road. The second angle threshold value THb is a positive value, that is, a gradient threshold value in the case of an uphill road. The angle threshold values THa and THb are any values that may be appropriately set. The angle threshold value THa is set to, for example, −5 degrees and the angle threshold value THb is set to, for example, +5 degrees.

When it is determined that the gradient of the road surface is within the range from the first angle threshold value THa to the second angle threshold value THb (S22; Yes), the in-video speed determination unit 406 sets the movement speed of the guide image within the video to be equal to the vertical movement speed of the circumference environment (S23).

When it is determined that the gradient of the road surface is out of the range from the first angle threshold value THa to the second angle threshold value THb (S22; No), the in-video speed determination unit 406 subsequently determines whether the gradient is less than the first angle threshold value THa (S24). When it is determined that the gradient is less than the angle threshold value THa (S24; Yes), that is, when the road surface is downhill at an inclination steeper than the first angle threshold value THa, the in-video speed determination unit 406 sets the movement speed of the guide image within the video to be faster than the vertical movement speed of the circumference environment (S25). When it is determined that the gradient is not less than the first angle threshold value THa (S24; No), the gradient is larger than the second angle threshold value THb, that is, the road surface is uphill at an inclination steeper than the second angle threshold value THb. In this case, the in-video speed determination unit 406 sets the movement speed of the guide image within the video to be slower than the vertical movement speed of the circumference environment (S26).

After the movement speed of the guide image is determined in any one of S23, S25, and S26, the video generation device 4 causes the video generation unit 407 to generate a video on the basis of the determined movement speed (S4), as illustrated in FIG. 3B. The video generation unit 407 reads data serving as materials for the video to be generated, including data of the guide image, from the storage unit 410 to generate the video. The video generation unit 407 transmits the generated video to the display control unit 408. Next, the video generation device 4 causes the display control unit 408 to display the video generated by the video generation unit 407 on the display device 5 (S5). When the processing in S5 is ended, the video generation device 4 starts a next video display process.

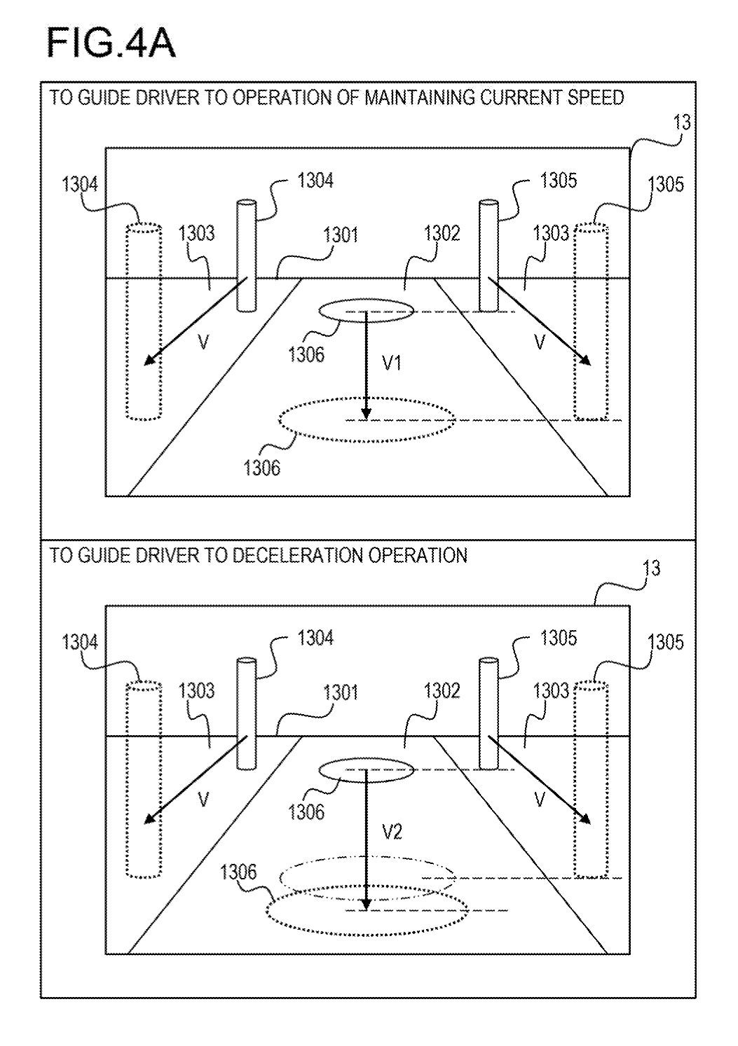

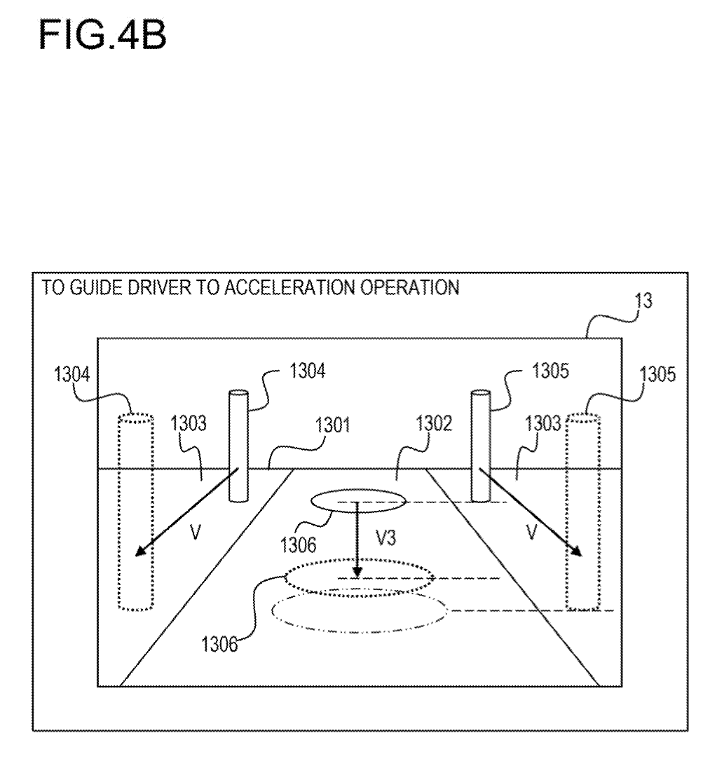

FIGS. 4A and 4B are diagrams illustrating examples of a displayed video. In the video, it is assumed that the own vehicle 9 is traveling in upward direction of the screen.

In the video display process according to the present embodiment, when the inter-vehicular distance between the own vehicle 9 and a vehicle in front is larger than a threshold value, the vehicular speed falls within an assumed range, and the road has a horizontal surface or a gentle slope, the movement speed of the guide image within the video is set to be equal to the vertical movement speed of the circumference environment (S23). In this case, the display device 5 displays, for example, a video 13 as illustrated in the upper part of FIG. 4A. A horizon 1301 is present near the center in the vertical direction of the video 13, and a lane 1302 where the vehicle 9 is traveling and road shoulders 1303 are displayed below the horizon 1301 in the video 13. On the road shoulders 1303 in the video 13, objects (for example, columnar objects 1304 and 1305) present around the vehicle are displayed. The columnar objects 1304 and 1305 within the video 13 move in the direction approaching the vehicle (the direction approaching the left or right edge of the screen) along the road surface edges (boundaries between the lane 1302 and the road shoulders 1303). The columnar objects 1304 and 1305 within the video 13 move at a movement velocity V corresponding to the traveling speed (vehicular speed) of the vehicle 9.

Further, in the video display process according to the present embodiment, for example, as illustrated in the upper part of FIG. 4A, a guide image 1306 is displayed on the lane 1302 within the video 13. When the inter-vehicular distance between the vehicle 9 and the vehicle in front is larger than the threshold value TH1, the guide image 1306 is caused to move at a movement speed V1 which is equal to a vertical component of the movement velocity V of the objects (the columnar objects 1304 and 1305) around the vehicle within the video.

At this time, the columnar objects 1304 and 1305, and the guide image 1306 are the same in the movement amount in the vehicle traveling direction (the vertical direction of the video 13), as illustrated in the upper part of FIG. 4A. The driver 10 viewing the video 13 tends to recognize that the guide image 1306 moves at the same speed as the vertical movement speed of the objects around the vehicle such as the columnar objects 1304 and 1305, and the guide image 1306 is one of the objects around the vehicle. Thus, when the video 13 is displayed in which the guide image 1306 is moving at the same speed as the vertical movement speed of the objects around the vehicle, such as the columnar objects 1304 and 1305, as illustrated in the upper part of FIG. 4A, the driver 10 is hardly guided to an acceleration or deceleration operation by the guide image 1306. Accordingly, when the video 13 is displayed in which the guide image 1306 is moving at the same speed as the vertical movement speed of the objects around the vehicle, the driver 10 continues to drive the vehicle while maintaining the current vehicular speed.

Meanwhile, in the video display process according to the present embodiment, in a case where the inter-vehicular distance from a vehicle in front is short, in a case where the vehicular speed is faster than the assumed range, or in a case where the road has a steep downhill surface, the movement speed of the guide image 1306 within the video 13 is set to be faster than the vertical movement speed of the circumference environment (S3, S15, and S25). That is, in the video 13 displayed in these cases, as illustrated in the lower part of FIG. 4A, a movement speed V2 of the guide image 1306 is larger than a velocity component, in downward direction of the screen, of the movement velocity V of the objects(the columnar objects 1304 and 1305) around the vehicle. Thus, in the video 13 in the lower part of FIG. 4A, the movement amount of the guide image 1306 is larger than the movement amount of the columnar objects 1304 and 1305 around the vehicle in a certain display period. The driver 10 viewing the video 13 feels that the guide image 1306 is approaching the vehicle 9 at a speed exceeding an assumed range. At this time, a visually induced self-motion illusion (vection) is imparted to the driver 10, in which the traveling speed of the own vehicle 9 is recognized as a speed faster than an actual speed. Therefore, when the video 13 is displayed in which the movement speed of the guide image 1306 is faster than the vertical movement speed of the circumference environment, the driver 10 tends to naturally perform an operation of decelerating the vehicle 9 so as to increase the distance from the guide image 1306. Accordingly, in a case where the inter-vehicular distance from the vehicle in front is short, the video 13 in which the movement speed of the guide image 1306 is faster than the vertical movement speed of the circumference environment is generated and displayed so as to guide the driver 10 to a deceleration operation to widen the inter-vehicular distance. Similarly, in a case where the vehicular speed is faster than the assumed range, or in a case where the road has a steep downhill surface, the video 13 in which the movement speed of the guide image 1306 is faster than the vertical movement speed of the circumference environment is generated and displayed so as to guide the driver 10 to a deceleration operation.

Also, in the video display process according to the present embodiment, in a case where the vehicular speed is slower than the assumed range, or in a case where the road has a steep uphill surface, the movement speed of the guide image 1306 within the video 13 is set to be slower than the vertical movement speed of the circumference environment (S14 and S26). That is, in the video 13 displayed in these cases, as illustrated in FIG. 4B, a movement speed V3 of the guide image 1306 is less than a velocity component, in downward direction of the screen, of the movement velocity V of the objects (the columnar objects 1304 and 1305) around the vehicle. Thus, in the video 13 in FIG. 4B, the movement amount of the guide image 1306 is less than the movement amount of the columnar objects 1304 and 1305 around the vehicle in a certain display period. The driver 10 viewing the video 13 feels that a distance between the guide image 1306 and the own vehicle 9 is widened. At this time, a vection is imparted to the driver 10, in which the traveling speed of the own vehicle 9 is recognized as a speed slower than an actual speed. Therefore, when the video 13 is displayed in which the movement speed of the guide image 1306 is slower than the vertical movement speed of the circumference environment, the driver 10 tends to naturally perform an operation of accelerating the vehicle 9 so as to decrease the distance from the guide image 1306. Accordingly, in a case where the vehicular speed is slower than the assumed range, or in a case where the road has a steep uphill surface, the video 13 in which the movement speed of the guide image 1306 is slower than the vertical movement speed of the circumference environment is generated and displayed so as to guide the driver 10 to an acceleration operation.

In the case where the traveling speed of the vehicle 9 is slower than the assumed range, for example, the inter-vehicular distance between the own vehicle 9 and another vehicle in the rear may be decreased, which may probably lead to a collision accident or traffic jam. In the case where the driver 10 does not notice that the own vehicle 9 is traveling on a steep uphill road, and thus continues to drive without changing a stepping amount of the accelerator, the vehicle 9 may be decelerated, which may probably lead to a traffic jam. Therefore, in a traveling state where the inter-vehicular distance from another vehicle is sufficiently secured, in the case where the traveling speed of the vehicle 9 is slower than the assumed range, or in the case where the road has a steep uphill surface, the occurrence of a rear-end collision accident or traffic jam may be prevented by guiding the driver 10 to an acceleration operation.

The video display process illustrated in FIGS. 3A to 3C is merely an example, and the order or contents of the process may be changed without departing from the gist of the present embodiment.

The videos 13 illustrated in FIGS. 4A and 4B are merely examples, and the shape or display method of the guide image 1306 may be appropriately changed. For example, when the inter-vehicular distance between the own vehicle 9 and a vehicle in front is larger than a threshold value, the vehicular speed falls within an assumed range, and the road has a horizontal surface or a gentle slope, the guide image 1306 within the video 13 may be fixed at a predetermined location on the lane 1302. In this case, when the driver 10 is to be guided to, for example, a deceleration operation, the video 13 is switched such that the guide image 1306 moves in the same direction (downwards on the screen) as that of the objects around the vehicle. Also, in this case, when the driver 10 is to be guided to an acceleration operation, the video 13 is switched such that the guide image 1306 moves in the opposite direction (upwards on the screen) to that of the objects around the vehicle.

### Second Embodiment

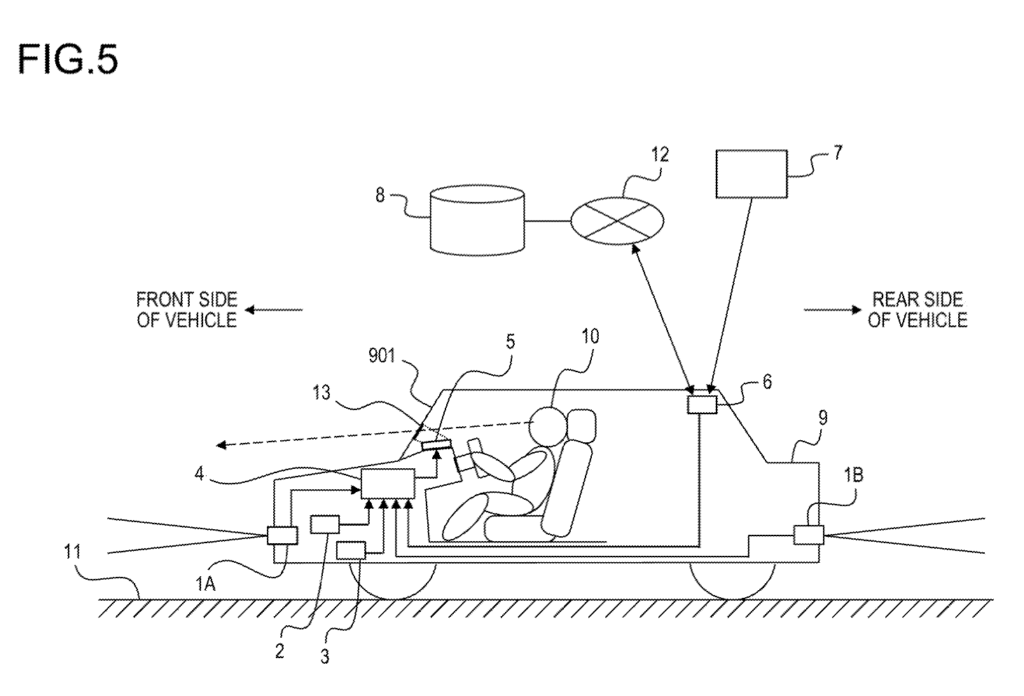

FIG. 5 is a diagram illustrating an exemplary configuration of a guide system according to a second embodiment.

As illustrated in FIG. 5, a guide system according to the second embodiment includes a first distance sensor 1A, a second distance sensor 1B, a vehicular speed sensor 2, a tilt sensor 3, a video generation device 4, a display device 5, and a radio communication device 6. Further, the guide system includes a position information provision device 7 and a speed limit DB 8. The first distance sensor 1A, the second distance sensor 1B, the vehicular speed sensor 2, the tilt sensor 3, the video generation device 4, the display device 5, and the radio communication device 6 are mounted in a vehicle 9.

The first distance sensor 1A is used to detect a distance between the vehicle 9 and an object such as another vehicle present in front (in a traveling direction) of the vehicle 9. The second distance sensor 1B is used to detect a distance between the vehicle 9 and an object such as another vehicle present behind the vehicle 9. The vehicular speed sensor 2 is used to detect a traveling speed of the vehicle 9. The tilt sensor 3 is used to detect an inclination angle of the vehicle 9 (the road surface where the vehicle 9 is traveling).

The video generation device 4 generates a video that guides a driver 10 of the vehicle 9 in relation to an operation of adjusting the traveling speed of the vehicle 9. Video generated by the video generation device 4 are generally classified into a video that guides the driver 10 to an operation of maintaining the current vehicular speed, a video that guides the driver 10 to a deceleration operation, and a video that guides the driver 10 to an acceleration operation. The video generation device 4 generates a video that guides the driver 10 on the basis of a speed limit of a road 11 where the vehicle 9 is traveling, a traveling speed of the vehicle 9, a distance from an object present in front of or behind the vehicle 9, an inclination angle of the vehicle 9, and the like. The video generation device 4 acquires position information of the vehicle 9 from the position information provision device 7 using a GPS or the like through the radio communication device 6. The video generation device 4 acquires the speed limit of the road 11 where the vehicle 9 is currently traveling from the speed limit DB 8 over a communication network 12 through the radio communication device 6.

The display device 5 displays a video generated by the video generation device 4. The display device 5 is provided to display the video generated by the video generation device 4 within the visual field of the driver 10 who is driving the vehicle 9. As the display device 5, for example, a head-up display (HUD) that projects and displays a video 13 on a windshield 901 or the like of the vehicle 9 may be used.

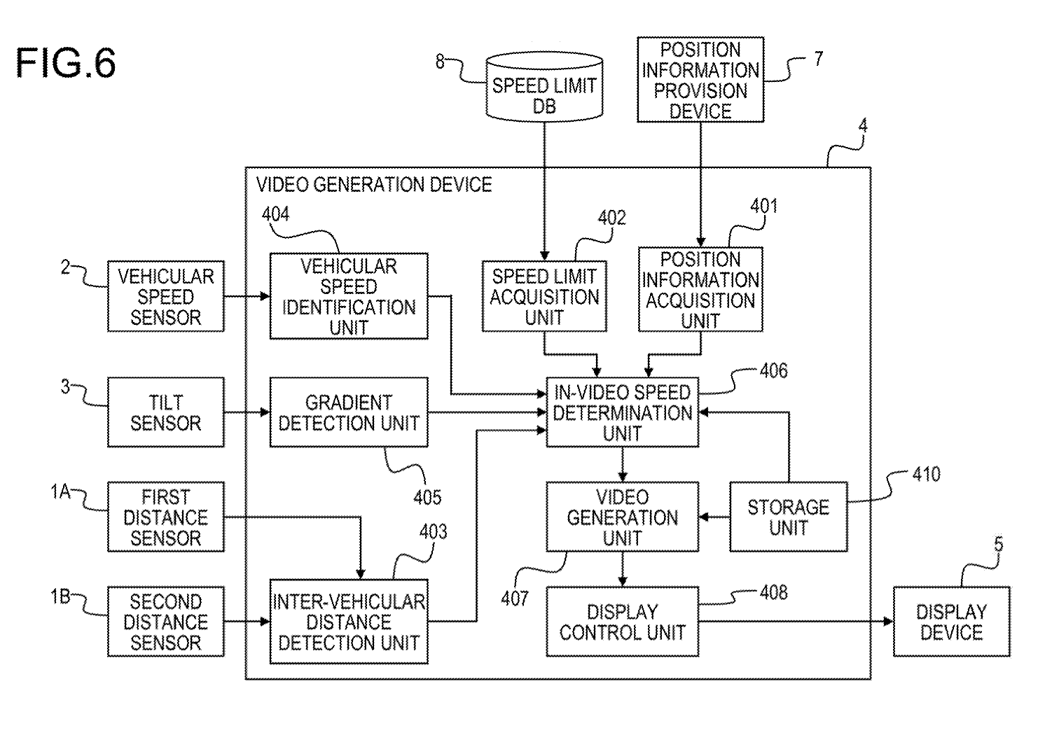

FIG. 6 is a diagram illustrating a functional configuration of the video generation device according to the second embodiment.

As illustrated in FIG. 6, the video generation device 4 includes a position information acquisition unit 401, a speed limit acquisition unit 402, an inter-vehicular distance detection unit 403, a vehicular speed identification unit 404, a gradient detection unit 405, an in-video speed determination unit 406, a video generation unit 407, and a display control unit 408. The video generation device 4 also includes a storage unit 410.

The position information acquisition unit 401 and the speed limit acquisition unit 402 are the same as the position information acquisition unit 401 and the speed limit acquisition unit 402, respectively, in the video generation device 4 according to the first embodiment.

The inter-vehicular distance detection unit 403 detects an inter-vehicular distance between an own vehicle and another vehicle present in front of the own vehicle on the basis of the output of the first distance sensor 1A. The inter-vehicular distance detection unit 403 also detects an inter-vehicular distance between the own vehicle and another vehicle present behind the own vehicle on the basis of the output of the second distance sensor 18.

The vehicular speed identification unit 404 and the gradient detection unit 405 are the same as the vehicular speed identification unit 404 and the gradient detection unit 405, respectively, in the video generation device 4 according to the first embodiment.

The in-video speed determination unit 406 determines a movement speed of a guide image within a video that guides the driver 10, on the basis of information such as the speed limit of the road 11 where the vehicle 9 is traveling, the traveling speed of the vehicle 9, the inter-vehicular distance ahead of or behind the vehicle, the gradient of the road 11, and information such as threshold values stored in the storage unit 410.

The video generation unit 407 and the display control unit 408 are the same as the video generation unit 407 and the display control unit 408, respectively, in the video generation device 4 according to the first embodiment.

In the storage unit 410, various threshold values used for determining the movement speed of the guide image, data serving as materials for the video, including data of the guide image, and the like are stored.

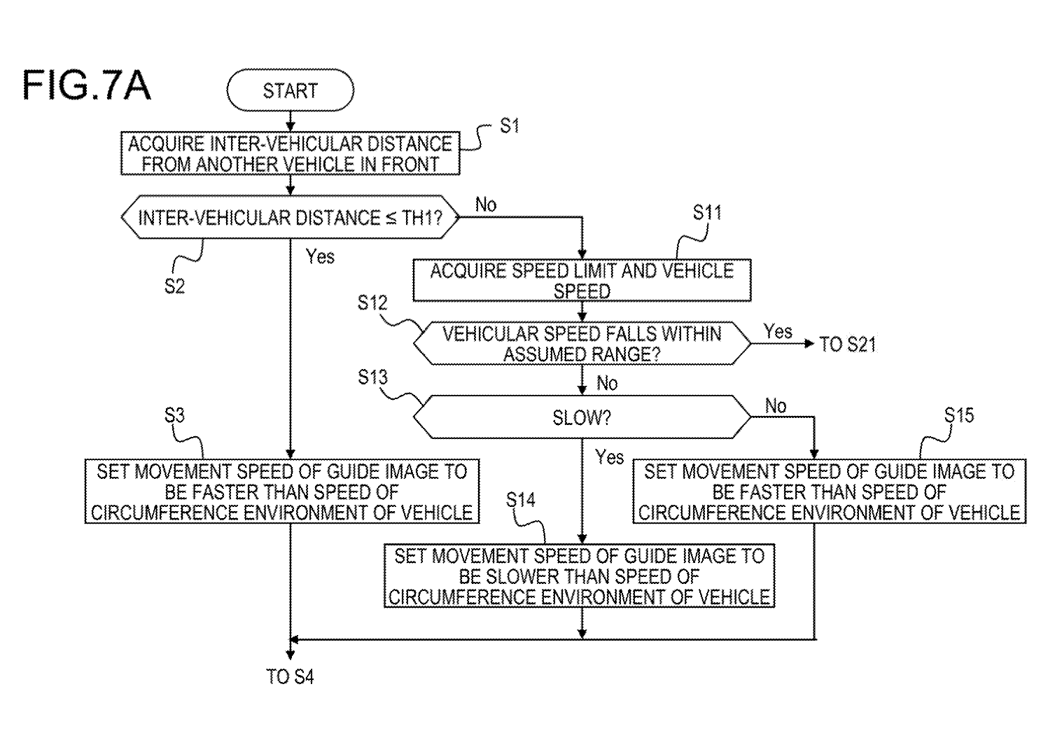

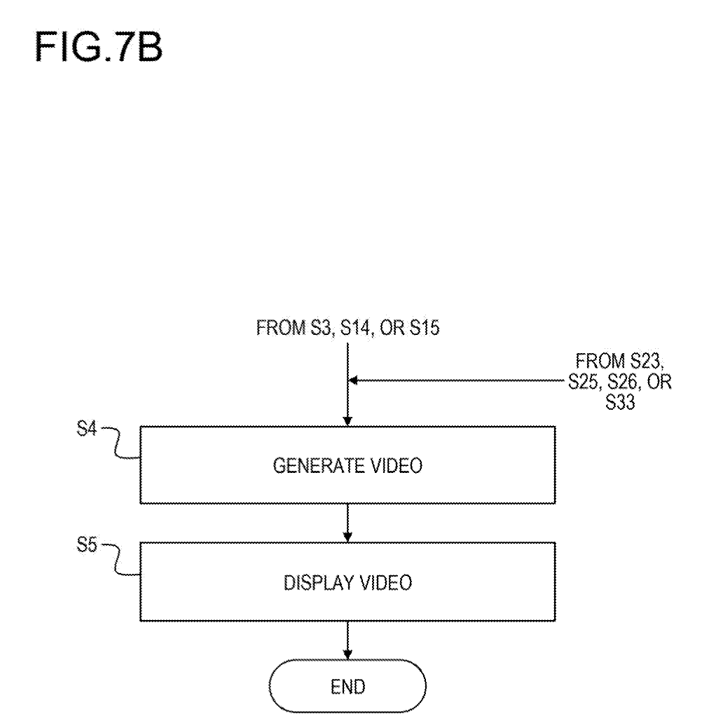

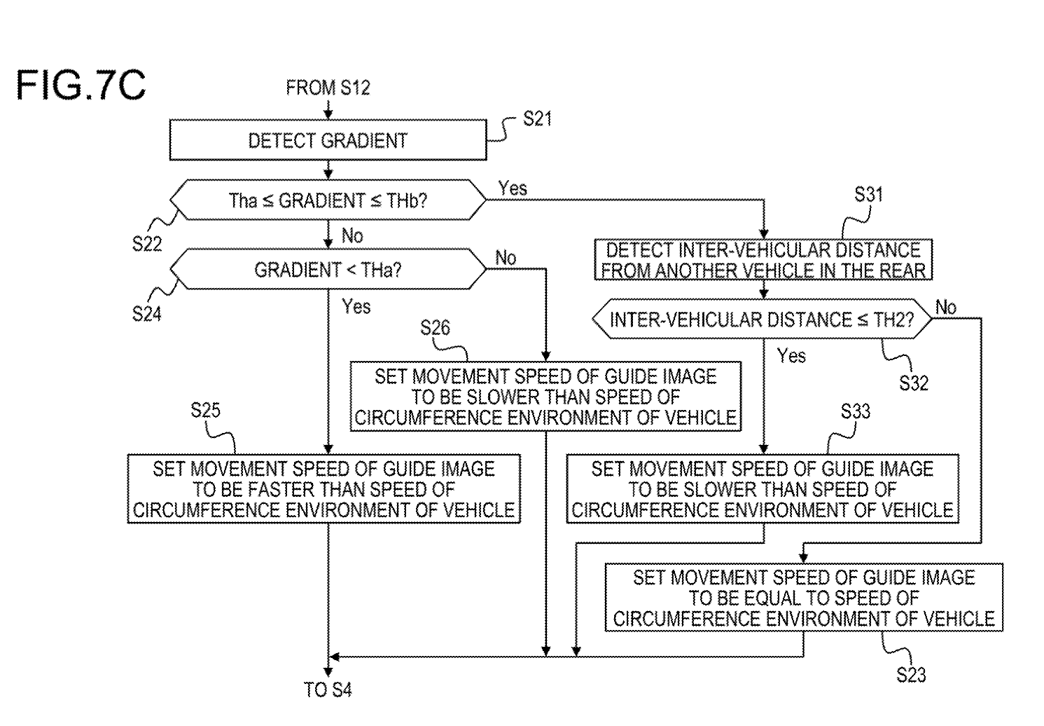

The video generation device 4 in the guide system according to the present embodiment repeatedly executes a video display process illustrated in FIGS. 7A to 7C at predetermined time intervals while the driver 10 drives the vehicle 9.

FIGS. 7A to 7C are flowcharts illustrating the video display process according to the second embodiment.

As illustrated in FIG. 7A, the video generation device 4 of the present embodiment acquires an inter-vehicular distance from another vehicle in front (S1). For example, the in-video speed determination unit 406 causes the inter-vehicular distance detection unit 403 to perform the processing in S1. The inter-vehicular distance detection unit 403 acquires the output of the first distance sensor 1A to detect (calculate) an inter-vehicular distance between the own vehicle and another vehicle present in front of the own vehicle. The inter-vehicular distance detection unit 403 notifies the in-video speed determination unit 406 of the detected inter-vehicular distance.

Next, the video generation device 4 causes the in-video speed determination unit 406 to determine whether the inter-vehicular distance is equal to or less than a first threshold value TH1 (S2).

When it is determined that the inter-vehicular distance is equal to or less than the threshold value TH1 (S2; Yes), the in-video speed determination unit 406 sets the movement speed of a guide image within a video to be faster than the vertical movement speed of the circumference environment on the basis of the distance from the vehicle in front (S3). In S3, the in-video speed determination unit 406 determines the movement speed of the guide image as a speed faster than a reference speed. The reference speed is, for example, the vertical movement speed of the circumference environment, which is determined on the basis of a current vehicular speed, a video size, or the like. The in-video speed determination unit 406 notifies the video generation unit 407 of the determined movement speed.

After the movement speed of the guide image is determined in S3, the video generation device 4 causes the video generation unit 407 to generate a video on the basis of the determined movement speed (S4), as illustrated in FIG. 7B. Next, the video generation device 4 causes the display control unit 408 to display the video generated by the video generation unit 407 on the display device 5 (S5). When the processing in S5 is ended, the video generation device 4 starts a next video display process.

When it is determined that the distance from the vehicle in front acquired in S1 exceeds the threshold value TH1 or when the inter-vehicular distance is not acquired in S1 (S2; No), the in-video speed determination unit 406 acquires a speed limit and a current vehicular speed (S11). In S11, the in-video speed determination unit 406 performs, for example, the same processing as that in S11 in the video display process according to the first embodiment.

When the processing in S11 is ended, the in-video speed determination unit 406 subsequently determines whether the vehicular speed falls within an assumed range (S12). In S12, the in-video speed determination unit 406 performs, for example, a determination under the same condition as that in S12 in the video display process according to the first embodiment. When it is determined that the current vehicular speed falls within the assumed range (S12; Yes), the in-video speed determination unit 406 subsequently performs processing in S21 as illustrated in FIG. 7C.

When it is determined that the current vehicular speed is out of the assumed range (S12; No), the in-video speed determination unit 406 subsequently determines whether the current vehicular speed is slower than the assumed range (S13). When it is determined that the vehicular speed is slower than the assumed range (S13; Yes), the in-video speed determination unit 406 sets the movement speed of the guide image within the video to be slower than the vertical movement speed of the circumference environment on the basis of the vehicular speed (S14). When it is determined that the vehicular speed is faster than the assumed range (S13; No), the in-video speed determination unit 406 sets the movement speed of the guide image within the video to be faster than the vertical movement speed of the circumference environment on the basis of the vehicular speed (S15). In S13, S14, and S15, the in-video speed determination unit 406 performs, for example, the same processing as those in S13, S14, and S15, respectively, in the video display process according to the first embodiment.

After the movement speed of the guide image is determined in S14 or S15, the video generation device 4 causes the video generation unit 407 to generate a video on the basis of the determined movement speed (S4), as illustrated in FIG. 7B. Next, the video generation device 4 causes the display control unit 408 to display the video generated by the video generation unit 407 on the display device 5 (S5). When the processing in S5 is ended, the video generation device 4 starts a next video display process.

When it is determined that the current vehicular speed falls within the assumed range (S12; Yes), as described above, the in-video speed determination unit 406 subsequently acquires a gradient of the road surface (the road 11) (S21) as illustrated in FIG. 7C. In S21, the in-video speed determination unit 406 performs, for example, the same processing as that in S21 in the video display process according to the first embodiment.

When the processing in S21 is ended, the in-video speed determination unit 406 subsequently determines whether the gradient is a first angle threshold value THa or more, and a second angle threshold value THb or less (S22). In S22, the in-video speed determination unit 406 performs, for example, a determination under the same condition as that in S22 in the video display process according to the first embodiment.

When it is determined that the gradient of the road surface is out of the range from the first angle threshold value THa to the second angle threshold value THb (S22; No), the in-video speed determination unit 406 subsequently determines whether the gradient is less than the first angle threshold value THa (S24). When it is determined that the gradient is less than the first angle threshold value THa (S24; Yes), that is, when the road surface is downhill at an inclination steeper than the first angle threshold value THa, the in-video speed determination unit 406 sets the movement speed of the guide image within the video to be faster than the vertical movement speed of the circumference environment (S25). When it is determined that the gradient is not less than the first angle threshold value THa (S24; No), the gradient is larger than the second angle threshold value THb, that is, the road surface is uphill at an inclination steeper than the second angle threshold value THb. In this case, the in-video speed determination unit 406 sets the movement speed of the guide image within the video to be slower than the vertical movement speed of the circumference environment (S26).

After the movement speed of the guide image is determined in any one of S25 and S26, the video generation device 4 causes the video generation unit 407 to generate a video on the basis of the determined movement speed (S4), as illustrated in FIG. 7B. Next, the video generation device 4 causes the display control unit 408 to display the video generated by the video generation unit 407 on the display device 5 (S5). When the processing in S5 is ended, the video generation device 4 starts a next video display process.

When it is determined that the gradient of the road surface is within the range from the first angle threshold value THa to the second angle threshold value THb (S22; Yes), the in-video speed determination unit 406 acquires an inter-vehicular distance from another vehicle in the rear (S31). For example, the in-video speed determination unit 406 causes the inter-vehicular distance detection unit 403 to perform the processing in S31. The inter-vehicular distance detection unit 403 acquires the output of the second distance sensor 18 to detect (calculate) an inter-vehicular distance between the own vehicle and another vehicle present behind the own vehicle. The inter-vehicular distance detection unit 403 notifies the in-video speed determination unit 406 of the detected inter-vehicular distance.

Next, the video generation device 4 causes the in-video speed determination unit 406 to determine whether the inter-vehicular distance from another vehicle in the rear is equal to or less than a second threshold value TH2 (S32).

When it is determined that the distance from another vehicle in the rear is equal to or less than the threshold value TH2 (S32; Yes), the in-video speed determination unit 406 sets the movement speed of the guide image within the video to be slower than the vertical movement speed of the circumference environment on the basis of the distance from another vehicle in the rear (S33). When the distance from another vehicle in the rear is larger than the threshold value TH2 (S32; No), the in-video speed determination unit 406 sets the movement speed of the guide image within the video to be equal to the vertical movement speed of the circumference environment (S23).

After the movement speed of the guide image is determined in any one of S23 and S33, the video generation device 4 causes the video generation unit 407 to generate a video on the basis of the determined movement speed (S4), as illustrated in FIG. 7B. Next, the video generation device 4 causes the display control unit 408 to display the video generated by the video generation unit 407 on the display device 5 (S5). When the processing in S5 is ended, the video generation device 4 starts a next video display process.

In the video display process according to the present embodiment, in a case where the inter-vehicular distances from the other vehicles are sufficiently long, the vehicular speed falls within an assumed range, and the road has a horizontal surface or a gentle slope, the movement speed of the guide image within the video is set to be equal to the vertical movement speed of the circumference environment (S23). In this case, the display device 5 displays, for example, a video 13 as illustrated in the upper part of FIG. 4A. Thus, in the case where the inter-vehicular distances from another vehicle in front and another vehicle in the rear are sufficiently long, the vehicular speed falls within the assumed range, and the road has a horizontal surface or a gentle slope, the driver 10 viewing the video 13 is guided to an operation of maintaining the current vehicular speed.

Meanwhile, in the video display process according to the present embodiment, in a case where the inter-vehicular distance from a vehicle in front is short, in a case where the vehicular speed exceeds the assumed range, or in a case where the road has a steep downhill surface, the movement speed of the guide image within the video is set to be faster than the vertical movement speed of the circumference environment (S3, S15, and S25). In these cases, the display device 5 displays, for example, the video 13 as illustrated in the lower part of FIG. 4A. Thus, in the case where the inter-vehicular distance from another vehicle in front is short, in the case where the vehicular speed exceeds the assumed range, or in the case where the road has a steep downhill surface, the driver 10 viewing the video 13 tends to be guided to a deceleration operation due to the vection.

Further, in the video display process according to the present embodiment, in a case where the vehicular speed is slower than an assumed range, in a case where the road has a steep uphill surface, or in a case where the inter-vehicular distance from another vehicle in the rear is short, the movement speed of the guide image within the video is set to be slower than the vertical movement speed of the circumference environment (S14, S26, and S33). In these cases, the display device 5 displays, for example, the video 13 as illustrated in FIG. 4B. Thus, in the case where the vehicular speed is slower than the assumed range, in the case where the road has a steep uphill surface, or in the case where the inter-vehicular distance from another vehicle in the rear is short, the driver 10 viewing the video 13 tends to be guided to an acceleration operation due to the vection.

As described above, in the video display process according to the present embodiment, in addition to the video display process according to the first embodiment, a video that guides the driver 10 to an acceleration operation is generated and displayed when the inter-vehicular distance from another vehicle in the rear is less than the threshold value TH2. Thus, when, for example, another vehicle joins from a frontage road and is approaching from the rear side of the own vehicle 9, the driver 10 may be temporarily guided to an acceleration operation so as to increase the inter-vehicular distance from the other vehicle in the rear.

The video display process illustrated in FIGS. 7A to 7C is merely an example, and the order or contents of the process may be changed without departing from the gist of the present embodiment.

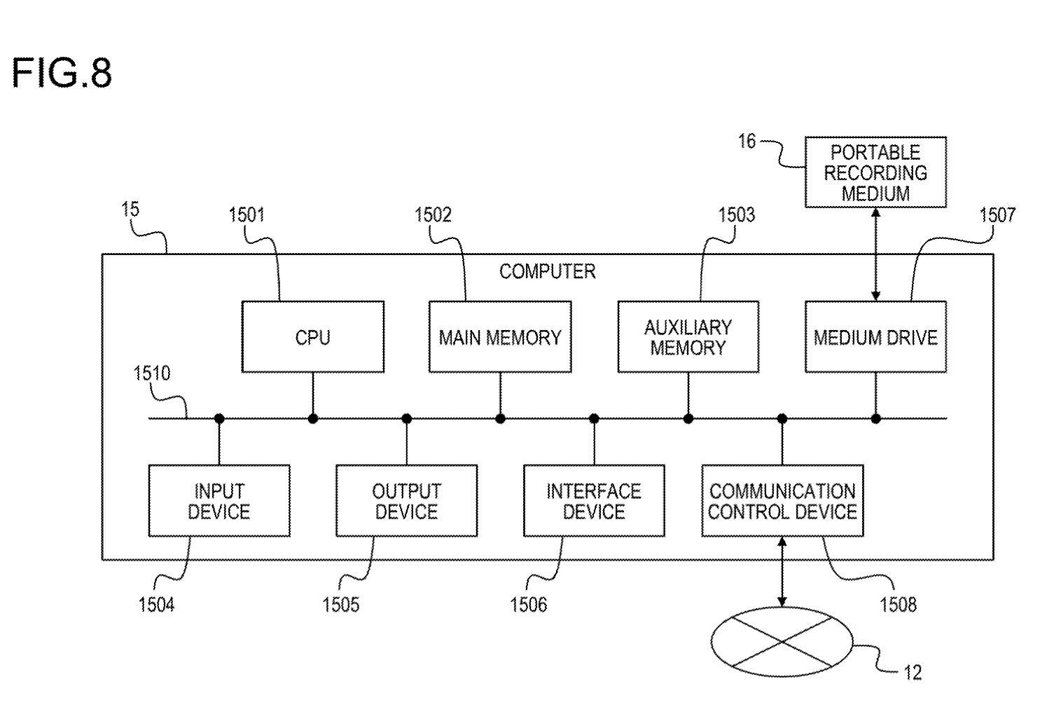

The video generation device 4 according to the first and second embodiments may be implemented using a computer and a program executed in the computer. Hereinafter, descriptions will be made on the video generation device 4 implemented using the computer and the program with reference to FIG. 8.

FIG. 8 is a diagram illustrating a hardware configuration of a computer.

As illustrated in the drawing, a computer 15 includes a central processing unit (CPU) 1501, a main memory 1502, an auxiliary memory 1503, an input device 1504, and an output device 1505. The computer 15 includes an interface device 1506, a medium drive 1507, and a communication control device 1508. These components 1501 to 1508 are coupled to each other via a bus 1510 in the computer 15 such that data is exchanged between the components.

The CPU 1501 is an arithmetic processing device that executes various programs including an operating system to control the overall operation of the computer 15.

The main memory 1502 includes a read-only memory (ROM) (not illustrated) and a random access memory (RAM) (not illustrated). In the ROM of the main memory 1502, for example, a predetermined basic control program or the like which is read by the CPU 1501 when the computer 15 starts up is recorded in advance. The RAM of the main memory 1502 is used as a working storage area as necessary when the CPU 1501 executes various programs. The RAM of the main memory 1502 may be used to store, for example, the position of the vehicle 9, the speed limit of the road 11, the inter-vehicular distance, the vehicular speed, the gradient of the road surface, various threshold values, and the like.

The auxiliary memory 1503 is a storage device such as a solid state drive (SSD), which has a larger capacity than the main memory 1502. In the auxiliary memory 1503, various programs to be executed by the CPU 1501, various data, and the like may be stored. The auxiliary memory 1503 may be used to store, for example, a program including any of video display processes exemplified in the first and second embodiments. The auxiliary memory 1503 may be used to store, for example, information such as the position of the vehicle 9, the speed limit of the road 11, and the inter-vehicular distance, and data serving as materials for the video, including a guide image. Further, the auxiliary memory 1503 may be used to store, for example, a display history of the video 13 including the guide image. When the computer 15 is mounted with a hard disk drive (HDD) connected to the bus 1510, the HDD may be used as the auxiliary memory 1503.

The input device 1504 is, for example, a keyboard device or a button switch. When an operator (driver or the like) of the computer 15 performs an operation such as pressing the input device 1504, the input device 1504 transmits input information associated with the operation content to the CPU 1501.

The output device 1505 is, for example, a liquid crystal display, a pilot lamp, a speaker, or the like. The output device 1505 is used to display a video including a guide image, to check an operating state of the computer 15, or the like. The output device 1505 may be a head-up display.

The interface device 1506 is a device that connects the computer 15 to another electronic device or the like, and is provided with a connector compliant with universal serial bus (USB) standards, or connector standards of a vehicle wiring harness. The device to be coupled to the computer 15 via the interface device 1506 may be, for example, the distance sensors 1A and 1B, the vehicular speed sensor 2, the tilt sensor 3, the display device 5 such as a head-up display (HUD), and various electronic control units (ECUs) mounted in the vehicle 9. A GPS receiver may also be an example of the device to be coupled to the computer 15 via the interface device 1506.

The medium drive 1507 reads a program or data recorded in a portable recording medium 16, or writes data or the like stored in the auxiliary memory 1503 to the portable recording medium 16. As the portable recording medium 16, for example, a flash memory provided with a USB-standard connector, a SD-standard memory card, or the like may be used. Also, in a case of the computer 15 mounted with an optical disk drive as the medium drive 1507, optical disks such as a compact disk (CD), a digital versatile disc (DVD), and a Blu-ray disc (Blu-ray is a registered trademark) may also be used as the portable recording medium 16. The portable recording medium 16 may be used to provide a program including any of video display processes exemplified in the first and second embodiments.

The communication control device 1508 is a device that communicably couples the computer 15 to the communication network 12 such as the Internet to control various communications between the computer 15 and another communication terminal (not illustrated) or the like through the communication network 12. The communication control device 1508 may be used to acquire the speed limit of the road where the vehicle 9 is traveling from the speed limit DB 8 over the communication network 12. By operating the computer 15 provided with the communication control device 1508 as the video generation device 4, for example, the display history (guide history) of the video including the guide image, which has been stored in the auxiliary memory 1503, may be transmitted to a predetermined server. When the guide histories accumulated in a plurality of computers 15 may be collectively managed by a server, for example, a transport service provider or the like is allowed to perform a safe driving evaluation, a driving guidance, or the like for each driver using the guide histories.

The CPU 1501 of the computer 15 reads a program including any of video display processes exemplified in respective embodiments from the auxiliary memory 1503 or the like to execute the read program, so that a video that guides the driver to an acceleration operation or a deceleration operation is generated and displayed on a display device. At this time, the CPU 1501 of the computer 15 operates as the inter-vehicular distance detection unit 403, the vehicular speed identification unit 404, the gradient detection unit 405, the in-video speed determination unit 406, the video generation unit 407, the display control unit 408, and the like in the video generation device 4. The RAM of the main memory 1502 or the auxiliary memory 1503 in the computer 15 serves as the storage unit 410 in the video generation device 4.

The computer 15 operating as the video generation device 4 does not need to include all of the components illustrated in FIG. 8, and some of the components may be omitted according to the applications or conditions. For example, when the computer 15 is an in-vehicle ECU, and is provided at a portion where the driver 10 is unable to operate the computer 15 while driving, the medium drive 1507 may be omitted from the computer 15. When the radio communication device 6 (see, e.g., FIG. 1) is provided in the vehicle 9 in addition to the computer 15 operating as the video generation device 4, the communication control device 1508 may be omitted from the computer 15.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A video generation device, comprising:
a memory; and
a processor coupled to the memory and the processor configured to
detect a second vehicle present in front of a first vehicle or behind the first vehicle in a first direction in which the first vehicle travels, the first vehicle being mounted with the video generation device,
detect a first distance between the first vehicle and the second vehicle upon detecting the second vehicle,
compare the first distance to a predetermined threshold value to acquire a first comparison result,
determine a first speed of a first image on basis of the first comparison result, the first image being included in a video and to be moved within the video in a direction determined on basis of the first direction,
generate the video on basis of the first speed, and
display the video via a display device.

2. The video generation device according to claim 1, wherein the processor is configured to
acquire a vehicular speed of the first vehicle, the vehicular speed being a speed at which the first vehicle is traveling, and
include a second image in the video, the second image being to be moved within the video at a second speed corresponding to the vehicular speed in a second direction determined on basis of the first direction.

3. The video generation device according to claim 2, wherein the processor is configured to
set the first speed to move the first image within the video in the second direction faster than the second speed when the second vehicle is present in front of the first vehicle in the first direction and when the first distance is equal to or less than the predetermined threshold value.

4. The video generation device according to claim 2, wherein the processor is configured to
set the first speed to move the first image within the video in the second direction slower than the second speed when the second vehicle is present behind the first vehicle in the first direction and when the first distance is equal to or less than the predetermined threshold value.

5. The video generation device according to claim 2, wherein the processor is configured to
set the first speed to move the first image within the video in a reverse direction of the second direction when the second vehicle is present behind the first vehicle in the first direction and when the first distance is equal to or less than the predetermined threshold value.

6. The video generation device according to claim 1, wherein the processor is configured to
acquire, when the first distance is larger than the predetermined threshold value or when the first distance is not detected, a speed limit of a road where the first vehicle is traveling and a vehicular speed of the first vehicle, the speed limit being a maximum speed at which the first vehicle is allowed to travel on the road, the vehicular speed being a speed at which the first vehicle is traveling on the road,
compare the vehicular speed to a range assumed on basis of the speed limit to acquire a second comparison result, and
determine the first speed on basis of the second comparison result.

7. The video generation device according to claim 6, wherein the processor is configured to
acquire the speed limit and the vehicular speed when the second vehicle is present in front of the first vehicle in the first direction and when the first distance is larger than the predetermined threshold value.

8. The video generation device according to claim 1, wherein the processor is configured to
detect, when the first distance is larger than the predetermined threshold value or when the first distance is not detected, a gradient of a road where the first vehicle is traveling,
compare the gradient to a predetermined range to acquire a second comparison result, and
determine the first speed on basis of the second comparison result.

9. The video generation device according to claim 8, wherein the processor is configured to
detect the gradient when the second vehicle is present in front of the first vehicle in the first direction and when the first distance is larger than the predetermined threshold value.

10. A video generation method, comprising:
detecting, by a computer mounted in a first vehicle, a second vehicle present in front of the first vehicle or behind the first vehicle in a first direction in which the first vehicle travels;
detecting a first distance between the first vehicle and the second vehicle upon detecting the second vehicle;
comparing the first distance to a predetermined threshold value to acquire a first comparison result;
determining a first speed of a first image on basis of the first comparison result, the first image being included in a video and to be moved within the video in a direction determined on basis of the first direction;
generating the video on basis of the first speed; and
displaying the video via a display device.

11. The video generation method according to claim 10, the method comprising:
acquiring a vehicular speed of the first vehicle, the vehicular speed being a speed at which the first vehicle is traveling; and
including a second image in the video, the second image being to be moved within the video at a second speed corresponding to the vehicular speed in a second direction determined on basis of the first direction.

12. The video generation method according to claim 11, the method comprising:
setting the first speed to move the first image within the video in the second direction faster than the second speed when the second vehicle is present in front of the first vehicle in the first direction and when the first distance is equal to or less than the predetermined threshold value.

13. The video generation method according to claim 11, the method comprising:
setting the first speed to move the first image within the video in the second direction slower than the second speed when the second vehicle is present behind the first vehicle in the first direction and when the first distance is equal to or less than the predetermined threshold value.

14. The video generation method according to claim 11, the method comprising:
setting the first speed to move the first image within the video in a reverse direction of the second direction when the second vehicle is present behind the first vehicle in the first direction and when the first distance is equal to or less than the predetermined threshold value.

15. The video generation method according to claim 10, the method comprising:
acquiring, when the first distance is larger than the predetermined threshold value or when the first distance is not detected, a speed limit of a road where the first vehicle is traveling and a vehicular speed of the first vehicle, the speed limit being a maximum speed at which the first vehicle is allowed to travel on the road, the vehicular speed being a speed at which the first vehicle is traveling on the road;
comparing the vehicular speed to a range assumed on basis of the speed limit to acquire a second comparison result; and
determining the first speed on basis of the second comparison result.

16. The video generation method according to claim 15, the method comprising:
acquiring the speed limit and the vehicular speed when the second vehicle is present in front of the first vehicle in the first direction and when the first distance is larger than the predetermined threshold value.

17. The video generation method according to claim 10, the method comprising:
detecting, when the first distance is larger than the predetermined threshold value or when the first distance is not detected, a gradient of a road where the first vehicle is traveling;
comparing the gradient to a predetermined range to acquire a second comparison result; and
determining the first speed on basis of the second comparison result.

18. The video generation method according to claim 17, the method comprising:
detecting the gradient when the second vehicle is present in front of the first vehicle in the first direction and when the first distance is larger than the predetermined threshold value.

19. A non-transitory computer-readable recording medium having stored therein a program that causes a computer mounted in a first vehicle to execute a process, the process comprising:
detecting a second vehicle present in front of the first vehicle or behind the first vehicle in a first direction in which the first vehicle travels;
detecting a first distance between the first vehicle and the second vehicle upon detecting the second vehicle;
comparing the first distance to a predetermined threshold value to acquire a first comparison result;
determining a first speed of a first image on basis of the first comparison result, the first image being included in a video and to be moved within the video in a direction determined on basis of the first direction;
generating the video on basis of the first speed; and
displaying the video via a display device.
